(19) United States
(12) Patent Application Publication
(10) Pub. No.: US 2025/0013504 A1
(43) Pub. Date: Jan. 9, 2025

(54) SYSTEMS AND METHODS FOR THRESHOLD BASED AUTOSCALING OF RESOURCES IN CLOUD COMPUTING ENVIRONMENTS

(71) Applicant: Argo AI, LLC, Pittsburgh, PA (US)

(72) Inventor: Marin Misur, Munich (DE)

(21) Appl. No.: 18/348,135

(22) Filed: Jul. 6, 2023

(51) Int. Cl. G06F 9/50; G06F 11/34

(52) U.S. Cl. CPC G06F 9/5077; G06F 9/505; G06F 11/3442

(57) ABSTRACT

Disclosed herein are system, method, and computer program product embodiments for autoscaling parameters of a computing environment. The methods include receiving a system metric that relates to usage of a computing resource associated with an application executed within the computing environment, and determining whether the system metric is within a desired operating range. When the system metric is determined to be not within the desired operating range, the methods also include determining a scaling rule for autoscaling one or more parameters of the computing environment based on a number of currently utilized computing resources, and autoscaling the one or more parameters of the computing environment to bring the system metric within the desired operating range.

### BACKGROUND

The emergence of cloud-computing resource providers and management tools for private virtualization clusters has allowed virtualized applications to be deployed on resources that may be changed or re-provisioned on an as-needed basis. Cloud computing environments are elastic in that they can be expanded or shrunk to meet the needs of users and computing tasks. For example, a developer who knows that his or her deployed application will receive only modest workloads may choose to run the application on an instance having allocated only a modest amount of resources. As time goes on, however, the developer may discover that the application is now receiving larger workloads and may consequently decide to upgrade larger instance and/or create a cluster of a plurality of small instances behind a load balancer. Should demand fall in the future, the developer may downgrade back to the single, small instance. The ability to provision and re-provision compute resources is thus a fundamental benefit of cloud computing and of virtualization in general; it allows one to ‘right-scale’ an application so that the resources upon which it is deployed match the computational demands it experiences and thus avoid paying for un-needed resources.

Expanding and shrinking elastic computing environments typically entail allocating and releasing resources (e.g., network bandwidth, memory, CPU cores or frequency, computing systems, etc.), which can be performed automatically in accordance with autoscaling thresholds. Autoscaling thresholds typically include an upper bound and a lower bound for a performance metric that trigger allocation or release, respectively, of a specified number of resources.

Improperly defined autoscaling parameters can result in unnecessary and/or ineffective autoscaling operations, both of which can increase operational costs and degrade performance of an elastic computing environment.

This document describes methods and systems that address issues such as those discussed above, and/or other issues.

### SUMMARY

In one or more scenarios, methods, systems, and computer program products for autoscaling parameters of a computing environment. The methods may include receiving a system metric that relates to usage of a computing resource associated with an application executed within the computing environment, and determining whether the system metric is within a desired operating range. When the system metric is determined to be not within the desired operating range, the methods may also include determining a scaling rule for autoscaling one or more parameters of the computing environment based on a number of currently utilized computing resources, and autoscaling the one or more parameters of the computing environment to bring the system metric within the desired operating range.

Implementing systems of the above-described methods can include, but are not limited to, a processor and a non-transitory computer-readable storage medium comprising programming instructions that are configured to cause the processor to implement a method for autoscaling parameters in a computing environment. Optionally, the programming instructions may be included in a computer program product.

### BRIEF DESCRIPTION OF THE DRAWINGS

The accompanying drawings are incorporated herein and form a part of the specification.

FIG. 1 is a block diagram of a networked environment according to some embodiments of the present disclosure.

FIG. 2 is a block diagram of an example orchestration system in communication with the autoscaler.

FIG. 3 illustrates an example number of unutilized resources using prior art autoscaling methods.

FIG. 4 illustrates an example number of unutilized resources using autoscaling methods of the current disclosure.

FIG. 5 illustrates an example autoscaling method in accordance with the current disclosure.

FIG. 6 is an example computer system useful for implementing various embodiments of this disclosure.

### DETAILED DESCRIPTION

Provided herein are system, apparatus, device, method and/or computer program product embodiments, and/or combinations and sub-combinations thereof, for, for example, a new autoscaling method and system to improve end-user experience and reduce compute resource costs.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” Definitions for additional terms that are relevant to this document are included at the end of this Detailed Description.

Companies and organizations operate computing environments including numerous interconnected computing systems to support their operations. The computing systems can be located in a single geographical location (e.g., as part of a local network) or located in multiple distinct geographical locations (e.g., connected via one or more private or public intermediate networks). Data centers may house significant numbers of interconnected computing systems, such as, e.g., private data centers are operated by a single organization and public data centers operated by third parties to provide computing resources to customers. Public and private data centers may provide network access, power, hardware resources (e.g., computing and storage), and secure installation facilities for hardware owned by the data center, an organization, or by other customers.

For microservices-based applications, virtual machines (VMs) could become inconvenient either because of coarse granularity or because of their management inconvenience. To facilitate increased utilization of data center resources, the use of application containers has become an increasingly popular way of executing applications on a host computer. Container-based virtualization or containerization is an alternative technology to the more traditional hypervisor based virtualization. In container-based virtualization, software applications/programs are executed within ‘containers’. Each container includes not only the application that needs to be executed but everything needed to run the application including runtime, system libraries, system tools, and settings. Accordingly, each container can be considered a deployable unit of software that packages up code and all its dependencies so that an application can run quickly and reliably from one computing environment to another. A container, therefore, provides for the isolation of a group of processes from the others on an operating system. Typically, in container-based virtualization, multiple containers share the hardware resources of a single operating system, but by making use of existing operating system functionality (such as Linux name spaces), containers maintain their own private view of the operating system, file system structure, and network interfaces. Containers share the operating system kernel with other processes but can be constrained to some extent to use an amount of resources such as the central processing unit (CPU), random access memory (RAM), or input/output (I/O) devices. Containers have proven advantageous because they typically have a small system “footprint.” That is, containers provide a relatively thin encapsulation layer above and beyond any applications contained therein. Thus, instantiation and deployment of containers is relatively quick.

As the scale and scope of data centers has increased, the task of provisioning, administering, and managing the physical and virtual computing resources of the data center has become increasingly challenging. Modern programs and distributed systems can require rapid scaling to avoid unacceptable performance degradation and the corresponding negative user experience. To manage the creation, destruction, deployment and scaling of containers, a number of container orchestration systems have been introduced. These include, e.g., Kubernetes, Docker Swarm, Nomad, etc. For example, Kubernetes provides horizontal autoscaling, vertical autoscaling, and cluster autoscaling solutions. Most of these container orchestration systems offer some sort of autoscaling capabilities—i.e., they are configured to monitor demand and automatically increase/decrease the available compute resources (i.e., processor and/or memory) for containers based on the monitored demand. However, most autoscaling capabilities offered by known container orchestration systems are configured to increase or decrease compute resources gradually and linearly. One problem, among others, is that it is often difficult to predict when such scaling will be necessary and the magnitude of scaling that will be required to prevent the performance issue. As such, current autoscaling solutions often cause under provisioning (the available resources are insufficient to handle the incoming workload), overprovisioning (more resources are allocated than necessary to handle the current workload), or oscillations (frequent changes in resource allocation causing instability and performance issues).

Embodiments of the present disclosure recognize that improperly defined autoscaling parameters can result in unnecessary and/or ineffective autoscaling operations, both of which can increase operational costs and degrade performance of an elastic computing environment. Embodiments of the present disclosure provide systems, methods, and computer products for defining autoscaling parameters, as well as alerting a user when, for example, autoscaling operations are not attainable given current operating configurations.

Therefore, embodiments of systems and methods are described for managing computing capacity associated with a program or set of programs. Illustratively, computing resources associated with a program may include program execution capabilities, data storage or management capabilities, network bandwidth, etc. In some implementations, one or more program owners can use a computing resource provider to host their programs. One or more program users can then use the computing resource provider to access those programs. Computing resource needs can be specified by a program owner, or they may be forecasted based on past usage and other factors. A desired operating range may also be specified by a program owner, or may be calculated by the computing resource provider. When the computing resource provider observes that a program requires additional or fewer resources to perform within the desired operating range, some portion of computing resources can be associated with or disassociate from the program. In some embodiments, the computing resources associated with a program may not exceed a forecasted upper threshold or fall below a forecasted lower threshold.

The pool of computing resources can include, for example, dozens, hundreds or thousands of computing nodes. A capacity manager can monitor the computing resources and applications associated with the computing resources over time intervals ranging from milliseconds to hours or longer. When computing resources are scaled up, the average time it takes for additional computing resources to be associated with an application, e.g., the mean time to traffic, can be a few (e.g., 2-3) minutes to an hour or more for various implementations. Certain embodiments of the systems and methods disclosed herein can provide reactive autoscaling of computing capacity substantially in real time (for example, on time scales comparable to the mean time to traffic).

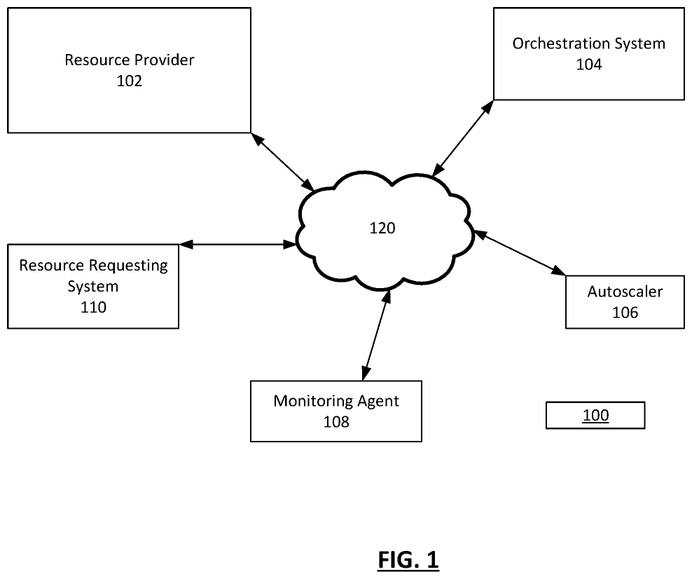

FIG. 1 illustrates an environment 100 in which one or more aspects of the present disclosure are implemented. Specifically, FIG. 1 illustrates the systems involved in automatically scaling compute resources. As used herein, compute resources refer to physical or virtual machines that are allocated predetermined units of CPU and memory.

The systems in environment 100 include a resource provider 102, an orchestration system 104, and an autoscaler 106, and a monitoring agent 108. The resource provider 102, orchestration system 104, autoscaler 106, and monitoring agent 108 communicate with each other over one or more communication networks 120. In addition to these core elements, the environment 100 further includes one or more resource requesting systems 110. The following section describes each of these systems and then proceeds to describe how they interact with each other.

The resource provider 102 provides infrastructure (i.e., the compute resources) required to execute scheduled jobs. The infrastructure may be provided via one or more on-premises data centers or one or more remote data centers hosted by a cloud service provider such as Amazon Web Services. Further, the resource provider 102 may assign infrastructure in the form of physical machines or virtual machines. A resource requesting system 110 may communicate with the resource provider 102 and request the resource provider to assign certain resources (e.g., CPU and memory) to the resource requesting system 110. The resource provider 102 in turn may then determine the number of physical and/or virtual machines that would be required to fulfil the desired CPU and memory requirements and assign these physical or virtual machines to the resource requesting system 110. The collection of compute resources assigned to the resource requesting system 110 at any given time is called a replica set or unit.

The resource provider 102 is also configured to increase or decrease the compute resources assigned in a replica set. In certain cases, the resource provider 102 may be configured to automatically scale the compute resources in the replica set based on metrics provided by the monitoring agent 108 (e.g., monitored demand, historical data, etc.). In other cases, the resource provider 102 may be configured to scale-up or scale-down the assigned number of assigned physical/virtual machines based on external instructions.

The orchestration system 104 is configured to automate the assignment and management of scheduled jobs. In particular, it is configured to assign jobs to the physical/virtual machines provided by the resource provider 102. To this end, the orchestration system 104 determines the virtual/physical machines assigned to a particular resource requesting system 110 and automatically assigns a scheduled job from the resource requesting system 110 to a virtual/physical machine assigned to that resource requesting system 110 or replica set. In addition, the orchestration system 104 is configured to manage job deployments and scale the underlying replica set based on demand.

In container-based virtualization, the orchestration system 104 is configured to receive job descriptors from the resource requesting system 110, create containers based on the received job descriptors and launch these containers on the physical/virtual machines in a replica set. Typically, the orchestration system 104 launches containers on the underlying machines in a manner that distributes the load evenly among the active machines. Examples of orchestration systems include Kubernetes. Docker Swarm, Titus, Nomad, etc.

For a particular resource requesting system 110, the autoscaler 106 is configured to determine real time resource requirements and scale up or scale down the resources to meet the resource requirements and prevent under provisioning, overprovisioning, and/or oscillating allocation of resources. In particular, the autoscaler 106 is configured to determine the available resources in a replica set and the required compute capacity and calculate a utilization of the underlying resources. If the resource utilization exceeds an upper tolerance threshold, the autoscaler 106 instructs the resource provider 102 to assign more resources to replica set. Alternatively, if the utilization is below a lower tolerance threshold, the autoscaler 106 may instruct the resource provider to terminate certain resources in the replica set.

Accordingly, the autoscaler 106 communicates with the orchestration system 104 to collect information about active compute resources and resource requirements and communicates with the resource provider 102 to instruct the resource provider to scale-up or scale-down the underlying resources.

The monitoring agent 108 is configured for monitoring application instances and virtual machine instances for metric information, such as states of virtual machine instances and states of application instances relating to computer processor usage, total number of CPUs, total CPU capacity, idle CPU capacity, memory, network utilization of application instances, runtime information, memory and network bandwidth, and number of virtual machine and application instances, etc. An example monitoring agent can be a Prometheus monitoring system, Dynatrace, Datadog, AppDynamics, and Instana, or the like.

Optionally, the metrices can be in the form of time series data collected in real time. The time-series data may include a measure of the virtualized application's usage of one or more computing resources (e.g., memory, CPU power, storage, or bandwidth) at a plurality of points in time. The data may describe the raw amount of resource usage (e.g., number of megabytes of storage), the percentage of a total of available resources consumed (e.g., 50% of available disk space), or any other such measure. The time points may be collected periodically every, for example, 30 seconds, 60 seconds, 5 minutes, 60 minutes, or any other interval. The frequency of data collection may vary if, for example, a resource limit is approaching, at which time more frequent samples may be collected. If resource use is well under its limit, fewer samples may be collected.

The resource requesting system 110 can be any system that creates and/or manages jobs (e.g., synthetic tests, builds, deployments, etc.). The resource requesting system 110 communicates with the resource provider 102 to provision infrastructure and communicates with the orchestration system 104 to provision one or more containers for executing the jobs on the provisioned infrastructure.

In one example, the resource requesting system 110 may be a continuous integration/continuous deployment tool that is configured to manage builds. The tool detects whether source code in a repository that is registered for continuous integration is updated, retrieves a build description associated with that source code from the repository, and creates a job description for initializing one or more containers to test and/or build the source code based on the build description. Along with other factors, the job description typically specifies an allocation of resources to complete the job. In certain embodiments, if the allocation of resources is not specified, a default amount of memory and CPU may be allocated to the job request. The orchestration system 104 utilizes this specified resource allocation to determine which underlying machine to allocate the job to.

In another example, the resource requesting system 110 may be a test management system that manages simulation tests (e.g., autonomous vehicle simulation tests). The test management system is typically responsible for receiving test requests from client devices, scheduling simulation tests based on test parameters included in the requests, and communicating descriptors of scheduled tests to the orchestration system 104. The test descriptors specify an allocation of resources to complete the test. The orchestration system 104 can then utilize the specified resource allocation to determine which underlying machine to allocate the tests to.

As illustrated in FIG. 1, communications between the various systems are via the communications network 120. The communication network 120 is depicted as a single network in FIG. 1 for ease of depiction. However, in actual implementation, the various systems illustrated in FIG. 1 may communicate with each other over different communication networks. For example, the container management system 104 and the resource provider 102 may communicate through one communication network whereas the autoscaler 106 and the orchestration system 104 may communicate over a different communication network. Similarly, the resource requesting systems 110 may communicate with the orchestration system 104 via a local network and with the resource provider 102 via a public network without departing from the scope of the present disclosure. Furthermore, the systems may communicate with each other over open web protocols such as (HTTPS, REST, and JWT).

Some of the implementation details of the autoscaling systems and methods of the present disclosure will be described with respect to an orchestration system 104 (e.g., Kubernetes). It will be appreciated that Kubernetes is merely used as an example to illustrate the calculations and the autoscaling methods described herein are not limited to operating with Kubernetes but can operate with other orchestration systems as well.

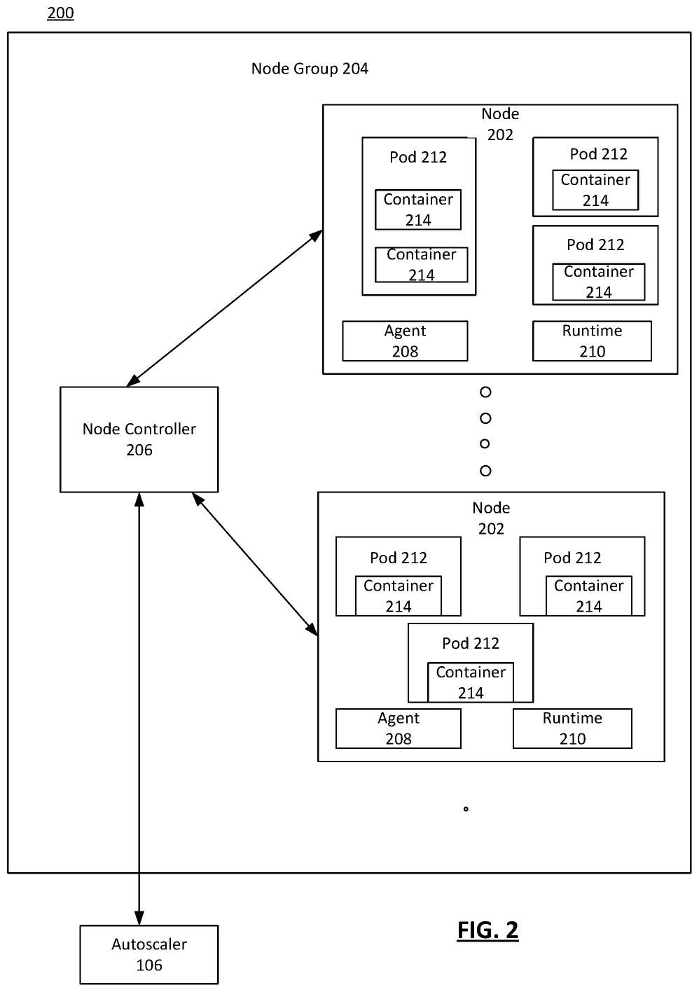

FIG. 2 illustrates an orchestration architecture 200 for Kubernetes. In Kubernetes, an underlying compute resource (i.e., a physical or virtual machine) is called a node 202. A cluster of such worker machines that are all assigned to the same replica set is called a node group 204. It will be appreciated that a node group is an abstracted version of a replica set. Different resource requesting systems 110 may be assigned different node groups. Each node 202 in a particular node group 204 directly correlates with a corresponding compute resource assigned to the resource requesting system 110 by the resource provider 102 and in this disclosure the terms node and compute resource may be interchangeably used. Further, each node 202 in the node group 204 contains the services necessary to run containers and is managed by a common node controller 206.

The node controller 206 typically manages a list of the nodes 202 in the node group 204 and synchronizes this list with the resource provider's list of machines assigned to that particular resource requesting system 110. The node controller 206 may also be configured to communicate with the resource provider 102 from time to time to determine if an underlying machine is still available or not. If an underlying machine is not available, the controller 206 is configured to delete the corresponding node 202 from its list of nodes. In this manner, the node controller 206 is always aware of the infrastructure assigned to the node group by the resource provider 102.

Each node includes an agent 208 that is configured to ensure that containers are running within the node and a runtime 210 that is responsible for running the containers. With the help of the agent 208 and runtime 210, one or more pods 212 may be launched on the active nodes 202 in a node group 204. A pod 212 is the basic building block of Kubernetes. A pod 212 encapsulates one or more containers 214, storage resources (not shown), and options that govern bow the containers 214 should run.

Typically, the node controller 206 can query the agent 208 running on each node 202 in the node group 204 to retrieve information about the nodes including the available resources on the node: the CPU, memory, and the maximum number of pods 212 that can be scheduled onto the node 202 at any given time. Further, the agent 208 can inform the controller 206 of all active pods on the node and the job requests scheduled for execution on the pods 212.

In some embodiments, the autoscaler 106 may be executed within a container inside the node group 204. In other implementations, the autoscaler 106 may be executed in a container outside the node group 204. In any event, the autoscaler 106 can communicate with the node controller 206 to obtain information about the nodes and the pods from time to time. For instance, the autoscaler 106 can request the controller 206 to provide a list of all nodes and active pods in the node group 204. Similarly, the autoscaler 206 may setup a “watch” on all the nodes and pods in the node group to receive a stream of updates for the nodes 202 and active pods 212 in the node group.

The autoscaler 106 of the current disclosure is configured to perform horizontal pod autoscaling in response to increased load by deploying more pods and/or replica sets. This is different from vertical scaling, which means assigning more resources (for example: memory or CPU) to the pods that are already running for the workload. If the load decreases, and the number of pods/replica sets is above the configured minimum, horizontal autoscaling causes reduction in the number of deployed pods/replica sets. The autoscaler 106 may be configured to specify the minimum and maximum number of pods/replica sets, as well as the CPU utilization or memory utilization the pods should target.

For horizontal scaling, the autoscaler monitors a metric (scaling metric) about an application and continuously adjust the number of replica sets to optimally meet the current demand. The autoscaler runs a control loop that queries the application (e.g., via the monitoring agent) for the current scaling metric value, calculates the desired number of replica sets or pods based on the scaling metric value, and scales the application to the desired number of replica sets or pods. The calculation of the desired number of replicas is based on the queried scaling metric and a target value for this metric. The goal is to calculate a replica count that brings the scaling metric value as close as possible to the target value. Specifically:

$$desiredRepls = ⌈ currentRepls \cdot \frac{currentMetricVal}{desiredMetricVal} ⌉ \text{?} \qquad ( 1 )$$

$$\text{?} \text{indicates text missing or illegible when filed}$$

Typically, the target value is fixed and supplied to the system by, for example, a user. The minimum and the maximum number of replicas may be set, and the autoscaler will respect these limits. If there is more than one metric used, the autoscaler may use the largest calculated desired replica set size. Furthermore, the scaling metric is typically a ratio (e.g., pod pod/replica utilization percentage also referred to as the resource utilization percentage) instead of absolute values of particular metrics.

As such, Equation 1 may be rewritten as:

$$currentMatricVal = {U}_{R} / {T}_{AR} \qquad ( 2 )$$

where, U_{R} is the number of utilized units of resource, and
T_{AR} is the total number of available units of resource.

By changing the number of replica sets, the autoscaler changes the T_{AR} value. However, autoscalers that rely on ratios are limited in their ability to distinguish between various situations that produce the same ratio because while the ratio between U_{R} and T_{AR} indicates the relative relationship between these variables, it does not provide any insight into the difference between them (i.e., T_{AR}−U_{R}), which represents the number of unused resource units. Moreover, the expense of idle resources is directly proportional to the size of this difference.

Specifically, If the currentMetric Val matches the desiredMetric Val, the autoscaler will not perform conduct any scaling, as implied by Equation 1, and Equation 2 can be rewritten as:

$${T}_{AR} - {U}_{R} = ( 1 - desiredMetricVal ) \cdot {T}_{AR} \qquad ( 3 )$$

Based on the above equation, manually selecting a single fixed value for desiredMetric Val that can effectively handle both smaller and larger workloads is non-trivial and often not possible. For example, if the ratio between the current and desired metric values is close to 1 (up to a configurable tolerance), the autoscaler will not attempt to perform any autoscaling leading to under provisioning and/or overprovisioning. Specifically, if desiredMetric Val is chosen to be relatively close to 1, the autoscaler will attempt to maintain T_{AR} as close as possible to the current U_{R} count, resulting in a negligible cost of idle replica units. However, this approach is problematic because provisioning new resource units requires time, so a sudden surge in workload can result in an underprovisioning scenario leading to performance degradation. On the other hand, if desiredMetricVal is selected to be closer to 0, autoscaler will aim to overprovision T_{AR} in all situations. This strategy allows the system to better handle underprovisioning scenarios during sudden bursts of additional workload. However, it leads to the overprovisioning scenario during periods of stable workload, resulting in significant idle unit costs.

Selecting desiredMetric Val to be a fixed value is not optimal as described below. For example, if the utilization ratio metric is the ratio between the resources being used and the total number of resources; a set target value (e.g., 50%) of the utilization ratio fails to distinguish between a first scenario when the total number of resources is 100 versus a second scenario when the total number of resources is 10,000. In the first scenario the number of idle resources to achieve the example set target value of 50% is 50 compared to the second scenario that leads to a much larger number of idle resource (5000) leading to increased costs of idle resources and inefficiencies even the target metric value is achieved. autoscale

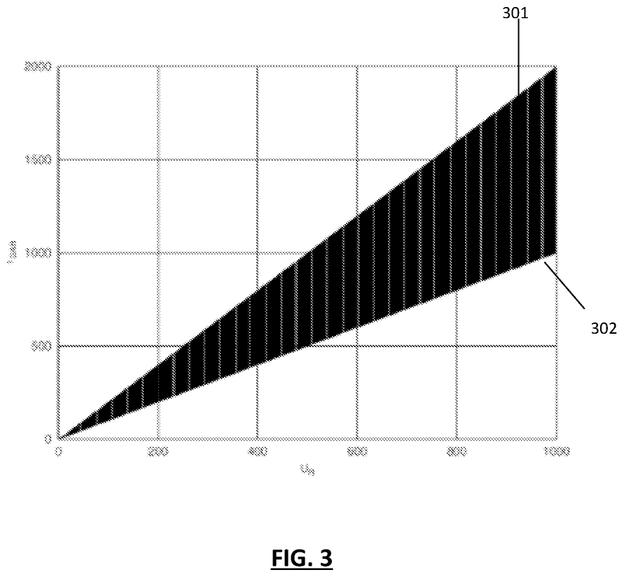

For example, FIG. 3 illustrates an example showing the number of unutilized resources (are between the lines 301 and 302) while still satisfying the target value (i.e., utilization ratio 50%). The line 301 represents the number of resources or pods made available to the system to achieve the target value of 50% at all time, while the line 302 illustrates the actual number of resources or pod being used. As shown in FIG. 3, the number of unutilized resources increases as the total number of available units of resources increases leading increasing wastage and inefficiencies. T_{DAR} is the number of available units that autoscaler tries to achieve by changing the number of replica sets for a given desired metric value.

The current disclosure describes systems and methods for dynamically setting the target value to address the above challenges. Specifically, the current disclosure describes a method for dynamically determining a desiredMetricVal that can strike a balance between minimizing the cost of idle replica units during periods of stable workload and avoiding underprovisioning scenarios during sudden bursts of additional workload.

Specifically, for a ratio based metric of equation (2), the autoscaler will not change the number of replica sets or pods as long as:

$${T}_{AR} = {U}_{R} / {T}_{1} \qquad ( 4 )$$

Where, T₁=desiredMetricVal, the desired (target) metric value provided by a user in equation (1).

For the fixed T₁, Equation (4) is equivalent to a definition of a line with slope 1/T₁ passing through the origin. As long the autoscaler scales to be consistent with the like, the target ratio (T₁ or desiredMetricVal) is achieved. In other words, for a given current number of utilized units of resource (U_{R}), it yields the desired total number of available units of resources (the desired T_{AR}) referred to as the T_{DAR}. The linear dependence of T_{DAR} with respect to U_{R} is shown by 301 in FIG. 3 for T₁=0.5.

The current disclosure overcomes the above challenges by changing equation (4) to define a scaling factor as follows (equation 5):

$${T}_{DAR} ( {U}_{R} ) = \{ \begin{matrix}{U}_{R} / {T}_{1} , & if {U}_{R} < {τ}_{1} & ( 5.1 ) \\ {α}_{1} \cdot {U}_{R} + {β}_{1} , & if {τ}_{1} \leq {U}_{R} < {τ}_{2} & ( 5.2 ) \\ ⋯ & ⋯ & \\ {α}_{n} \cdot {U}_{R} + {β}_{n} , & if {U}_{R} \geq {τ}_{n} , & ( 5.3 )\end{matrix}$$

Where, τ1, τ2 . . . τn are positive threshold values; and α1, α2 . . . αn and β1, β2 . . . βn are constants that may be provided by a user and/or automatically determined based on real-historical data of the system. For example, the threshold may be determined as the average number of resources being utilized by the system over a period of time divided by a constant (e.g., 1, 2, 3, etc.).

Optionally, the values for α and β may be constrained to ensured that T_{DAR} remains a continuous function around the threshold value τ. In the absence of such continuity, T_{DAR} may cause larger than required scale-ups and scale-downs, particularly when U_{R} oscillates around the threshold value t leading to a combination of underprovisioning and overprovisioning within a brief timeframe.

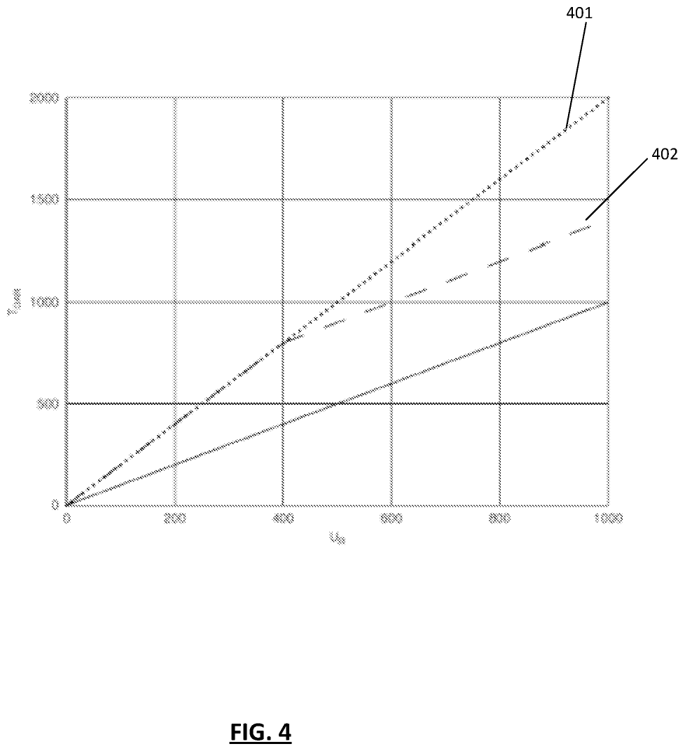

Specifically, for U_{R}<τ1, the autoscaler utilizes the equation U_{R}/T₁ for scaling of resources, for τ1<U_{R}<τ2, the autoscaler utilizes the equation α1. U_{R}+β1 for scaling of resources, and so on. FIG. 4 illustrates the reduction in the number of idle or unutilized replica units obtained for T₁=0.5, τ=400, α=1, and β=400. Line 401 illustrates the number of resources made available for achieving a fixed T₁=0.5 using equation 5.1, while line 402 represents the number of resources made available using equation 5.2 once the threshold number of utilized resources (i.e., U_{R}=τ=400) is reached. As shown in FIG. 4 the number of unutilized resources under line 402 is significantly lower. In various embodiments, the current U_{R} may be determined based on the metrics received from the monitoring agent, and the T_{DAR} determined accordingly under the dynamic scaling approach of this disclosure.

The presently disclosed autoscaling systems and methods achieve provide a dynamic buffer capacity when calculating resource requirements (using the scaling of equations 5.1, 5.2, and 5.3). In particular, the autoscaling systems and methods calculate the capacity (e.g., processor and memory requirements) required to perform scheduled tasks and the actual capacity (e.g., the available processor and memory) available to determine the utilization of the assigned resources. If the utilization is determined to be above a threshold In (which can be set to include the buffer capacity), the resources (i.e., replicas) are scaled up or down while keeping the total number of unutilized resources in check (e.g., using equation 5.3). Alternatively, if the utilization is determined to be above a first threshold τ₁ but below a second threshold τ₂, the resources are scaled up or down using equation 5.2 (i.e., the number of unutilized resources compared to the total number of resources is higher than in the first instance). Optionally, if the utilization is determined to be below the first threshold T₁, the resources are scaled up or down (e.g., using equation 5.1).

This calculation and decision making is performed periodically—e.g., every 30 seconds, every minute, every 5 minutes, and so on depending on the type of job-based workloads the autoscaling system is configured to handle. Furthermore, the first and/or second thresholds may be programmed or predetermined based on the amount of buffer required in the event of a spike in scheduled jobs.

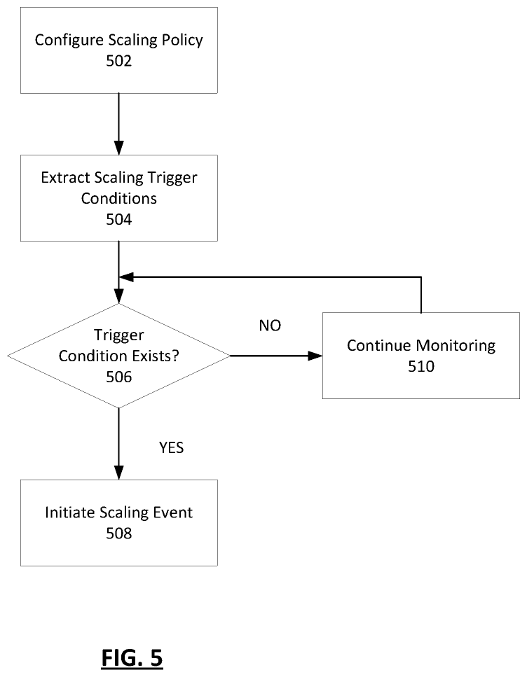

FIG. 5 is a flowchart illustrating an example method for autoscaling applications in a cloud computing environment (e.g., the computing environment of FIG. 1), in accordance with an embodiment of the present invention. The example method 500 is described in terms of a system metric that indicates an operating state of a program, and the parameters that the methods utilize for performing calculations on, e.g., capacity bands, adjustment rules, lower and/or upper thresholds, and the like.

At step 502, the system may configure a scaling policy. In an example embodiment, be configured based on user input related to cloud resource management. In the exemplary embodiment, the scaling policy includes, without limitation, one or more trigger conditions, and one or more scaling rules for scaling-up and/or scaling-down shared cloud resources based, at least in part, on the one or more trigger conditions or parameters (such as number of resources being used). Optionally, the rules to scale-up may be the same as the rules to scale-down. In one embodiment, the one or more trigger conditions relate to various states of a plurality of measurement metrics, including, without limitation, states of virtual machine instances and states of application instances relating to computer processor usage, total number of CPUs, total CPU capacity, idle CPU capacity, memory, resource utilization, network utilization of application instances, runtime information, memory and network bandwidth, and number of virtual machine and application instances, etc. In one embodiment, the one or more rules for scaling-up and scaling-down shared cloud resources can include, without limitation, rules to scale-up (i.e., when application needs more resources than presently allocated), and/or rules to scale-down (i.e., when application utilizes less resources than presently provisioned). In the exemplary embodiment, the one or more rules establish upper and lower thresholds for state conditions and monitor information, such that when the upper and lower thresholds are exceeded (i.e., a trigger condition exists), a scaling action automatically reallocates resources to bring shared resources within established upper and lower thresholds (i.e., scaling rules). For example, an upper tolerance threshold for α performance metric, expressed as a percentage, that, if exceeded during performance of a requested computing task, can trigger an autoscaling operation for upscaling; while a lower tolerance threshold for the performance metric, expressed as a percentage, below which an autoscaling operation can be triggered for downscaling. The autoscaling itself is performed in accordance with equation (5) discussed above.

The system may then extract scaling trigger conditions from the scaling policy (504). For example, the system may extract one or more trigger conditions from the scaling policy by referencing the one or more trigger conditions (e.g., optional T_{DAR} value or range) provided in the scaling policy and select each of the one or more trigger conditions relevant to the scope of autoscaling desired. For example, if it is desirable to autoscale applications when a certain percentage of CPU capacity is exceeded, autoscaling policy will extract each of the one or more trigger conditions relevant to CPU capacity by selecting each of the one or more trigger conditions provided in the scaling policy pertaining to CPU capacity. An example trigger is, for example, when T_{AR} (i.e., the current total number of available units of resources as determined by the current state of the system) and T_{DAR} (the number of available resources desired by the autoscaler as calculated by autoscaler using Equations 5) don't match by a difference that is greater than a tolerance threshold.

At 506, the triggers may be used to monitor information related to application instance(s) and performance metrics to determine whether a trigger condition exists.

In response to determining that a trigger condition exists, the system may initiate a scaling event (e.g., via the autoscaler) (508). In an example embodiment, monitoring agent may initiate a notification to autoscaler that a trigger condition exists, prompting autoscaler to determine a scaling decision based, at least in part, on the one or more rules related to the trigger condition.

In various embodiments, the scale up and down rule may be defined using equation (5) discussed above. Autoscaling is triggered when the difference between the current metric value and the desired metric value is not within a tolerance threshold associated with the current metric. Once triggered, the rule for autoscaling may be selected based on the number of resources being currently used. As discussed, U_{R}<τ1, the autoscaler utilizes the equation U_{R}/T₁ for scaling of resources such that the autoscaler increases (scales up) or decreases (scales down) T_{AR} based on the number utilized resources (U_{R}). On the other hand, for 11<U_{R}<2, the autoscaler utilizes the equation α1. U_{R}+β1 for scaling of resources such that the autoscaler increases (scales up) or decreases (scales down) T_{AR} based on the number utilized resources (U_{R}) to achieve a T_{DAR} defined by equation (5). An optimal T_{DAR} (and/or T_{DAR} range) may be determined based on, for example, historical data, user instructions, machine learning algorithms, time period, desired efficiency, etc.

The various thresholds and scalar constants may be received form a user and/or determined based on historical data for configuration of the scaling policy. For example, and without limitation, the system may use a median value of the number of utilized resources and the target value (desiredMetric Val) to define the first threshold; then the 75th percentile and the target value (desiredMetricVal) to define the second threshold, and so on. Once the thresholds are defined, the system may define a piecewise linear functions between them using two (distinct) points that it passes through. For example, the first linear function (the one defined between 0 and the first threshold value—i.e., equation 5.1) may be defined by the target value (desiredMetric Val) because it will pass through (0,0), and a point determined by the first threshold and the target value (desiredMetric Val). For the second linear function (between the first and the second thresholds—i.e., equation 5.2) may be determined using a point defined at the threshold point of the first function and a second point (at the second threshold). The second point may be derived based on user instructions and/or historical data. This in turn would define the first point for α third function where a second point of the third function may provide by a user (or determined based on historical data), and so on.

For initiating the scaling event, the system may first determine the autoscaling rule to be used based on, for example, the number of resources being used (U_{R}). For example, the monitoring agent may monitor application usage information for α particular application instance relative to available resources on a node, and if the usage information indicates that the number of resources being used is greater than a first threshold (τ1) but less than a second threshold (τ2), the system may initiate a scaling event for adding a new replicas or pods to handle the application usage requirements (or removing pods) in order to achieve a T_{DAR} that is equal to α1. U_{R}+β1. On the other hand, if the usage information indicates that the number of resources being used is less than a first threshold (τ1), the system may scale to achieve a T_{DAR} that is equal to U_{R}/T₁. In another example, the system may determine that an application's wait time for α CPU exceeds a particular wait time threshold, the application's memory is occupied, and the application's input/output is blocked. The system may correlate these conditions to determine whether a trigger condition exists, and if so, initiates a scaling event to either scale-up or scale-down based on the present conditions.

In response to determining that a trigger condition does not exist, the system may continue monitoring the computing environment (510).

A person having ordinary skill in the art can understand that scaling rules, thresholds, trigger conditions, monitoring metrics, and the like are fully configurable, and may include other examples not included in the foregoing discussion.

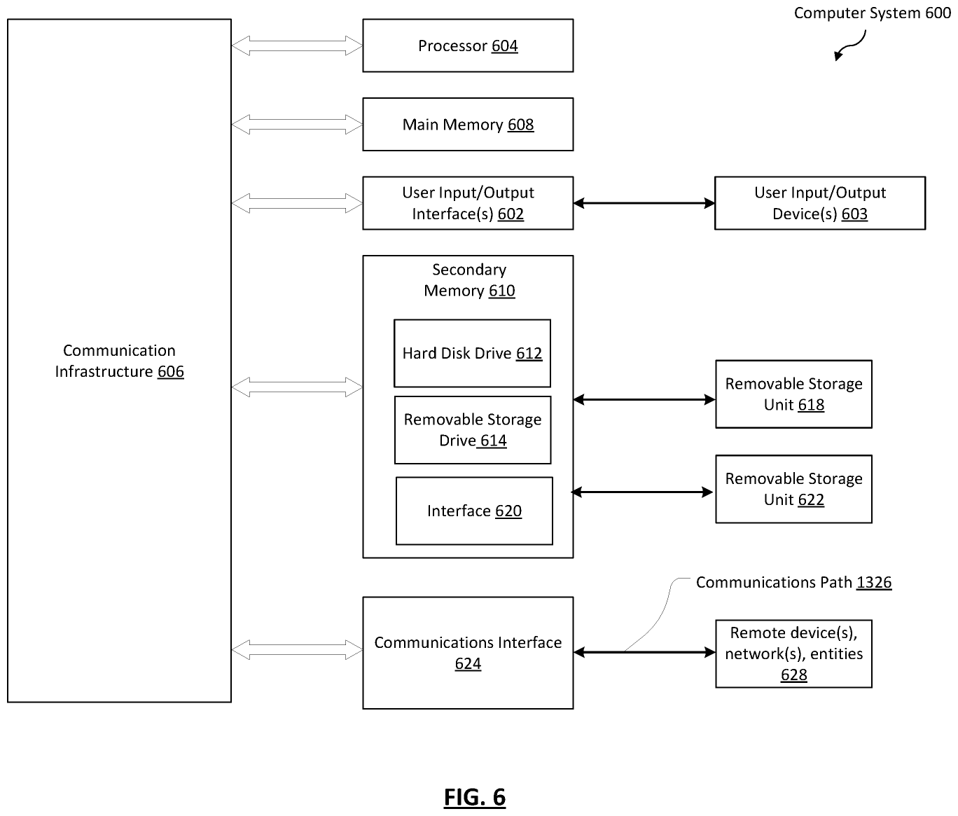

Various embodiments can be implemented, for example, using one or more computer systems, such as computer system 600 shown in FIG. 6. Computer system 600 can be any well-known computer capable of performing the functions described herein. Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 616, such as monitors, keyboards, pointing devices, etc., that communicate with communication infrastructure 606 through user input/output interface(s) 602.

Computer system 600 also includes a main or primary memory 608, such as random-access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an example embodiment, secondary memory 610 may include other means, instrumentalities, or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way. The features from different embodiments disclosed herein may be freely combined. For example, one or more features from a method embodiment may be combined with any of the system or product embodiments. Similarly, features from a system or product embodiment may be combined with any of the method embodiments herein disclosed.

As described above, this document discloses system, method, and computer program product embodiments for autoscaling of resources in computing environments are disclosed. The computer program embodiments include programming instructions (e.g., stored in a memory), to cause a processor to perform the autoscaling methods described in this document. The system embodiments also include a processor which is configured to perform the autoscaling methods described in this document, e.g., via the programming instructions. More generally, the system embodiments include a system comprising means to perform the steps of the any of the methods described in this document.

In various embodiments, the methods may include receiving a system metric that relates to usage of a computing resource associated with an application executed within the computing environment, and determining whether the system metric is within a desired operating range. When the system metric is determined to be not within the desired operating range, the methods may also include determining a scaling rule for autoscaling one or more parameters of the computing environment based on a number of currently utilized computing resources, and auto-scaling the one or more parameters of the computing environment to bring the system metric within the desired operating range.

In the above embodiments, the methods may also include receiving and storing a scaling policy that includes one or more scaling rules and corresponding one or more ranges of the number of currently utilized computing resources. Optionally, the one or more scaling rules may be configured to determine a number of unutilized computing resources based on a total number of available computing resources.

In any of the above embodiments, determining, based on the number of currently utilized computing resources, the scaling rule for autoscaling one or more parameters of the computing environment may include determining whether the number of currently utilized resources is less than a threshold. Optionally, the methods may also include determining the threshold based on at least one of the following: historical data associated with the computing environment, one or more system parameters, or user feedback. Additionally and/or alternatively, a ratio of the number of currently utilized resources to a desired system metric may be used to determine the number of unutilized computing resources during autoscaling when the number of currently utilized resources is less than the threshold. Optionally, the methods may include using multiple of the number of currently utilized resources added to a scalar constant as the number of unutilized computing resources during autoscaling when the number of currently utilized resources is more than the threshold.

In any of the above embodiments, the desired system metric value may be a utilization ratio of the computing resources for executing the application.

In any of the above embodiments, the system metric may relate to CPU utilization, network bandwidth, network latency, computing resource accessibility, persistent storage utilization, memory utilization, transactions, requests, number of users accessing the program, a length of time the program has been running in the program execution service, or traffic to the computing resources.

In any of the above embodiments, the methods may also include continuous monitoring of metrices associated of the computing environment for receiving the system metric. Terminology that is relevant to the disclosure provided above includes:

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” and the like each refer to a non-transitory device on which computer-readable data, programming instructions or both are stored. The terms “storage,” “storage device,” and “disk storage” specifically refer to a non-transitory device, such as a hard drive (HDD) or solid-state drive (SDD), that stores data persistently for α relatively longer period. The term “memory” may be used generally in this document to refer either to a storage device that stores information on a persistent basis, or to a device that stores information on a non-persistent basis such as a random access memory (RAM) device. Except where specifically stated otherwise, the terms “memory,” “memory device,” “storage,” “disk storage,” “storage device” and the like are intended to include single device embodiments, embodiments in which multiple devices together or collectively store a set of data or instructions, as well as individual sectors within such devices. A “storage location” is a segment, sector, or portion of a storage device. The relative terms “first storage location” and “second storage location” refer to different storage locations, which may be elements of a single device or elements of multiple devices.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

In this document, when relative terms of order such as “first” and “second” are used to modify a noun, such use is simply intended to distinguish one item from another, and is not intended to require a sequential order unless specifically stated. In addition, terms of relative position such as “front” and “rear”, or “ahead” and “behind”, when used, are intended to be relative to each other and need not be absolute, and only refer to one possible position of the device associated with those terms depending on the device's orientation.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

The features from different embodiments disclosed herein may be freely combined. For example, one or more features from a method embodiment may be combined with any of the system or product embodiments. Similarly, features from a system or product embodiment may be combined with any of the method embodiments herein disclosed.

The breadth and scope of this disclosure should not be limited by any of the above-described example embodiments but should be defined only in accordance with the following claims and their equivalents.

As described above, this document discloses system, method, and computer program product embodiments for generating vehicle trajectories. The system embodiments include a processor or computing device implementing the methods for generating vehicle trajectories. The computer program embodiments include programming instructions, for example, stored in a memory, to cause a processor to perform the methods described in this document. The system embodiments also include a processor which is configured to perform the methods described in this document, for example, via the programming instructions. More generally, the system embodiments include a system comprising means to perform the steps of any of the methods described in this document.

Without excluding further possible embodiments, certain example embodiments are summarized in the following clauses.

Clause 1: A method for autoscaling parameters of a computing environment, the method comprising, by a processor
receiving a system metric that relates to usage of a computing resource associated with an application executed within the computing environment;
determining whether the system metric is within a desired operating range; and
in response to a determining that the system metric is not within the desired operating range:
determining, based on a number of currently utilized computing resources, a scaling rule for autoscaling one or more parameters of the computing environment, and
autoscaling the one or more parameters of the computing environment to bring the system metric within the desired operating range.

Clause 2. The method of clause 1, further comprising receiving and storing a scaling policy, the scaling policy comprising one or more scaling rules and corresponding one or more ranges of the number of currently utilized computing resources.

Clause 3. The method of clause 2, wherein the one or more scaling rules are configured to determine a number of unutilized computing resources based on a total number of available computing resources.

Clause 4. The method of any of the above clauses, wherein determining, based on the number of currently utilized computing resources, the scaling rule for autoscaling one or more parameters of the computing environment comprises determining whether the number of currently utilized resources is less than a threshold.

Clause 5. The method of clause 4, further comprising determining the threshold based on at least one of the following: historical data associated with the computing environment, one or more system parameters, or user feedback.

Clause 6. The method of clause 4, further comprising upon determining that the number of currently utilized resources is less than the threshold, using a ratio of the number of currently utilized resources to a desired system metric to determine the number of unutilized computing resources during autoscaling.

Clause 7. The method of clause 4, further comprising upon determining that the number of currently utilized resources is more than the threshold, using multiple of the number of currently utilized resources added to a scalar constant as the number of unutilized computing resources during autoscaling.

Clause 8. The method of any of the above clauses, wherein the desired system metric value is a utilization ratio of the computing resources for executing the application.

Clause 9. The method of any of the above clauses, wherein the system metric is associated with at least one of the following: a processing utilization, a network bandwidth, a network latency, a computing resource accessibility, a persistent storage utilization, a memory utilization, a number of transactions, a number of requests, a number of users accessing the application, a length of time the application has been running, or traffic to the one or more computing resources.

Clause 10. The method of any of the above clauses, further comprising continuous monitoring of metrices associated of the computing environment for receiving the system metric.

Clause 11. A system comprising means for performing steps of any of the above method clauses.

Clause 12. A computer program, or a storage medium storing the computer program, comprising instructions, which when executed by one or more suitable processors cause any of the processors to perform the steps of any of the above method clauses.

Clause 13. A system for autoscaling parameters of a computing environment, the system comprising:
a processor; and
programming instructions stored in a memory and configured to cause the processor to:
receive a system metric that relates to usage of a computing resource associated with an application executed within the computing environment;
determine whether the system metric is within a desired operating range; and
in response to a determining that the system metric is not within the desired operating range:
determine, based on a number of currently utilized computing resources, a scaling rule for autoscaling one or more parameters of the computing environment, and
autoscale the one or more parameters of the computing environment to bring the system metric within the desired operating range.

Clause 14. The system of clause 13, further comprising programming instructions that are configured the cause the processor to receive and store a scaling policy, the scaling policy comprising one or more scaling rules and corresponding one or more ranges of the number of currently utilized computing resources.

Clause 15. The system of clause 14, wherein the one or more scaling rules are configured to determine a number of unutilized computing resources based on a total number of available computing resources.

Clause 16. The system of any of the above system clauses, wherein the programming instructions that are configured to cause the processor to determine, based on the number of currently utilized computing resources, the scaling rule for autoscaling one or more parameters of the computing environment comprise programming instructions to cause the processor to determine whether the number of currently utilized resources is less than a threshold.

Clause 17. The system of clause 16, further comprising programming instructions that are configured to cause the processor to determine the threshold based on at least one of the following: historical data associated with the computing environment, one or more system parameters, or user feedback.

Clause 18. The system of clause 16, further comprising programming instructions that are configured to cause the processor to, upon determining that the number of currently utilized resources is less than the threshold, use a ratio of the number of currently utilized resources to a desired system metric to determine the number of unutilized computing resources during autoscaling.

Clause 19. The system of clause 16, further comprising programming instructions that are configured to cause the processor to, upon determining that the number of currently utilized resources is more than the threshold, use multiple of the number of currently utilized resources added to a scalar constant as the number of unutilized computing resources during autoscaling.

Clause 20. The system of any of the above system clauses, wherein the desired system metric value is a utilization ratio of the computing resources for executing the application.

Clause 21. The system of any of the above system clauses, wherein the system metric is associated with at least one of the following: a processing utilization, a network bandwidth, a network latency, a computing resource accessibility, a persistent storage utilization, a memory utilization, a number of transactions, a number of requests, a number of users accessing the application, a length of time the application has been running, or traffic to the one or more computing resources.

Clause 22. A computer program product comprising a non-transitory computer-readable medium that stores instructions that, when executed by a computing device, will cause the computing device to perform operations comprising:
receiving a system metric that relates to usage of a computing resource associated with an application executed within the computing environment;
determining whether the system metric is within a desired operating range; and
in response to a determining that the system metric is not within the desired operating range:
determining, based on a number of currently utilized computing resources, a scaling rule for autoscaling one or more parameters of the computing environment, and
autoscaling the one or more parameters of the computing environment to bring the system metric within the desired operating range.

What is claimed is:

1. A method for autoscaling parameters of a computing environment, the method comprising, by a processor:
receiving a system metric that relates to usage of one or more computing resources associated with an application executed within the computing environment;
determining whether the system metric is within a desired operating range; and
in response to a determining that the system metric is not within the desired operating range:
determining, based on a number of currently utilized computing resources, a scaling rule for autoscaling one or more parameters of the computing environment, and
autoscaling the one or more parameters of the computing environment to bring the system metric within the desired operating range.

2. The method of claim 1, further comprising receiving and storing a scaling policy, the scaling policy comprising one or more scaling rules and corresponding one or more ranges of the number of currently utilized computing resources.

3. The method of claim 2, wherein the one or more scaling rules are configured to determine a number of unutilized computing resources based on a total number of available computing resources.

4. The method of claim 1, wherein determining, based on the number of currently utilized computing resources, the scaling rule for autoscaling one or more parameters of the computing environment comprises determining whether the number of currently utilized computing resources is less than a threshold.

5. The method of claim 4, further comprising determining the threshold based on at least one of the following: historical data associated with the computing environment, one or more system parameters, or user feedback.

6. The method of claim 4, further comprising upon determining that the number of currently utilized computing resources is less than the threshold, using a ratio of the number of currently utilized computing resources to a desired system metric to determine a number of unutilized computing resources during autoscaling.

7. The method of claim 4, further comprising upon determining that the number of currently utilized resources is more than the threshold, using a multiple of the number of currently utilized computing resources added to a scalar constant as a number of unutilized computing resources during autoscaling.

8. The method of claim 1, wherein the desired system metric value is a utilization ratio of the one or more computing resources for executing the application.

9. The method of claim 1, wherein the system metric is associated with at least one of the following: a processing utilization, a network bandwidth, a network latency, a computing resource accessibility, a persistent storage utilization, a memory utilization, a number of transactions, a number of requests, a number of users accessing the application, a length of time the application has been running, or traffic to the one or more computing resources.

10. The method of claim 1, further comprising continuous monitoring of metrices associated of the computing environment for receiving the system metric.

11. A system for autoscaling parameters of a computing environment, the system comprising:
a processor; and
programming instructions stored in a memory and configured to cause the processor to:
receive a system metric that relates to usage of a computing resource associated with an application executed within the computing environment;
determine whether the system metric is within a desired operating range; and
in response to a determining that the system metric is not within the desired operating range:
determine, based on a number of currently utilized computing resources, a scaling rule for autoscaling one or more parameters of the computing environment, and
autoscale the one or more parameters of the computing environment to bring the system metric within the desired operating range.

12. The system of claim 11, further comprising programming instructions that are configured to cause the processor to receive and store a scaling policy, the scaling policy comprising one or more scaling rules and corresponding one or more ranges of the number of currently utilized computing resources.

13. The system of claim 12, wherein the one or more scaling rules are configured to determine a number of unutilized computing resources based on a total number of available computing resources.

14. The system of claim 11, wherein the programming instructions that are configured to cause the processor to determine, based on the number of currently utilized computing resources, the scaling rule for autoscaling one or more parameters of the computing environment comprise programming instructions to cause the processor to determine whether the number of currently utilized resources is less than a threshold.

15. The system of claim 14, further comprising programming instructions that are configured to cause the processor to determine the threshold based on at least one of the following: historical data associated with the computing environment, one or more system parameters, or user feedback.

16. The system of claim 14, further comprising programming instructions that are configured to cause the processor to, upon determining that the number of currently utilized computing resources is less than the threshold, use a ratio of a number of currently utilized resources to a desired system metric to determine a number of unutilized computing resources during autoscaling.

17. The system of claim 14, further comprising programming instructions that are configured to cause the processor to, upon determining that the number of currently utilized computing resources is more than the threshold, use a multiple of the number of currently utilized computing resources added to a scalar constant as a number of unutilized computing resources during autoscaling.

18. The system of claim 11, wherein the desired system metric value is a utilization ratio of the one or more computing resources for executing the application.

19. The system of claim 11, wherein the system metric is associated with at least one of the following: a processing utilization, a network bandwidth, a network latency, a computing resource accessibility, a persistent storage utilization, a memory utilization, a number of transactions, a number of requests, a number of users accessing the application, a length of time the application has been running, or traffic to the one or more computing resources.

20. A computer program product comprising a non-transitory computer-readable medium that stores instructions that, when executed by a computing device, will cause the computing device to perform operations comprising:
receiving a system metric that relates to usage of a computing resource associated with an application executed within the computing environment;
determining whether the system metric is within a desired operating range; and
in response to a determining that the system metric is not within the desired operating range:
determining, based on a number of currently utilized computing resources, a scaling rule for autoscaling one or more parameters of the computing environment, and
autoscaling the one or more parameters of the computing environment to bring the system metric within the desired operating range.
